(19) United States
(12) Patent Application Publication
(10) Pub. No.: US 2013/0209959 A1
(43) Pub. Date: Aug. 15, 2013

(54) INTER LOCKING IMPLANTS

(71) Applicant: Michael Peer, Nahariya (IL)

(72) Inventor: Michael Peer, Nahariya (IL)

(21) Appl. No.: 13/369,647

(22) Filed: Feb. 9, 2012

(51) Int. Cl. A61C 8/00

(52) U.S. Cl. 433/174

(57) ABSTRACT

The present invention relates to a method of joining two implants together so as to enhance the immediate stability of both implants, allowing immediate loading. Both implants are inserted in an angle to the jaw and are locked together, thus forming a compound structure that improves stability and enhances resistance to rotational, occlusal and lateral forces.

### FIELD OF THE INVENTION

The present invention relates in general to the field of implant dentistry. More specifically, this invention relates to a combination of two dental implants allowing the function of immediate loading after the implants placement.

### BACKGROUND OF THE INVENTION

In the past decades the field of dental implants evolved considerably. Branemark of Sweden found that osseointegration, i.e. the integration between a titanium-alloy implant and the jaw bone, can bear the forces of mastication, thus allowing the fabrication of a fixed or detachable dental apparatus on the implant. Branemark's perception was that in order to achieve successful osseointegration, it's imperative to prevent any loading after placing the implant for a period of 3-6 months, in order to avoid fibrous encapsulation of the implant. This delayed loading protocol was devised to prevent micromotion of the implant during the healing period. It is the excess of micromotion during the healing phase that interferes with bone repair.

The delayed healing protocol has its drawbacks, especially in edentulous patients and in cases that involve restorations of the anterior segments of the mouth.

Several types of implants were suggested in order to prevent micromobilty, thus allowing the dental practice of immediate loading, i.e., loading the implant within a period of 0-96 hours after it's placement in the jaw.

Some designs of prior implants used a mechanism that utilizes an internal screw in order to expand plural apical legs radially and outwardly into the bone thus causing an anchoring effect. U.S. Pat. No. 2,721,387 was issued to Ashuckian (1955) for a dental implant with apical expansion design. U.S. Pat. No. 3,708,883 was issued to Flander (1973) for an implant with two expanding legs in the apical side of the implant. Similar concepts were utilized in apical expansion designs by Lazarof (1992) U.S. Pat. No. 5,087,199, and U.S. Pat. No. 5,681,187 Lazarof (1997), and Hanosh (1996) U.S. Pat. No. 5,489,210, and U.S. Patent No. 2010/0304333 A1 (Ghavidel) That show expandable dental implants. The problem with all these designs is the risk of micro-leakage of bacteria and other microorganisms from the oral cavity, through the micro gaps that exist between the female threads of the internal channel and the male threads of the expansion screw. Other drawbacks of these designs can be breakage of the expanding legs at their bases and damage to the peripheral bone during expansion.

Another kind of expanding implant is described in U.S. Pat. No. 6,227,860 issued to Hobo (2001). In this implant the expanding part is in the middle of the spindle shaped implant. Still, there might be a problem with micro-leakage even in this design, hence the need for a locking system that doesn't include those longitudinal channels along the whole length of implants, which might be a vessel for various microorganisms.

One of the problems when the need comes for multiple implants is the lack of bone height and the poor quality of bone especially in the posterior parts of the oral cavity. The absence of bone led to the development of full arch prostheses which use only four supporting implants. Paolo Malo from Nobel Biocare introduced the “All-On-Four” concept in which a full arch prosthesis is supported by four implants. The immediate stability of the supporting implants is essential in those cases of minimum bone volume.

Inserting an implant to the bone in an oblique angle can add up to fifty percent more to the length of the inserted implant, allowing more bone-to-implant contact and improved support. Hence insertion of two tilted implants increases the bone-to-implant contact by up to 100 percent. Furthermore, tilting the implants can provide the necessary gap between the coronal ends of the implants or the abutments for a stable support of a dental superstructure.

Our present invention can resolve the problem by allowing the insertion of longer implants obliquely into the jaw and securing the two implants together, thus allowing sufficient stability for immediate loading. The splinting of 2 implants can also enhance the stability to eccentric forces.

Most modern dental implants have either one piece or two piece designs without any internal channel. Our present invention uses such one or two piece dental implants, made from titanium/titanium alloy or ceramic/zirconium compounds. The lack of internal channels that vessel the expansion screws up to the apical side of the implant reduces the possibility of micro-leakage in said one piece or two piece implants. When using two piece tilted implants, an angled abutment can be used to allow proper seating of the dental prostheses. U.S. Patent No. 2011/0027756 A1 (Benatouil) describes one-piece inclined dental implant and its advantages compared to two piece implants. U.S. Patent No. 2009/0298013 A1 (Baruc) describes an inclined abutment assembly device that can be attached to a standard two piece implant.

To position the implants one may use Computer Aided Design (CAD) procedures. The three dimensional model can aid in fabrication of a surgical template and in selecting the appropriate length and width of the implants. It is possible to fabricate the dental bridge prior to placing the implants and using a template device for transferring the position of an angled abutment from a model to an implant as described in U.S. Patent No. 2009/0047628 A1 (Malo).

### SUMMARY OF THE INVENTION

The following summary is a simplified description of some embodiments of the present invention. A more detailed description is discussed later. In one embodiment a combination of two inclined dental implants forms a coupled structure that enhances resistance to rotational, occlusal and lateral forces allowing immediate loading of said dental implants thereof. The said first implant has an angled threaded bore at the apical end and said second implant comprises an upper coronal threaded shaft and a thinner apical threaded part fitted for the said bore, wherein the second implant is inserted in an angle unto said angled bore located in the apical part of the first implant.

Furthermore, to facilitate the proper angled drilling for the said coupled implants, our present invention suggests a device comprised of a cylindrical implant body try-in with the desirable angle, width, length and an angled bore at the apical end of the try-in, and an attachment member which is connected to the implant try-in. The connecting member comes with a tilted sleeve for inserting a drill in a desired angle for the second implant.

### BRIEF DESCRIPTION OF THE DRAWINGS

The features and advantages of the present invention are herein described, by way of example only, with reference to the accompanying drawings, in which:

FIG. 1 provides a perspective view of the two implants locked together in an angle.

FIG. 2 provides a perspective view of the locked implants with internal hex heads.

FIG. 3 comprises front (A), side (B) and sectional (C) views of one embodiment of the first implant.

FIG. 4 shows a front view of the second implant.

FIG. 5 shows sectional and side view of one embodiment of the first implant.

FIG. 6 shows embodiments of one piece implants (A) and two piece implants (B) locked together.

FIG. 7 shows a sectional view (A) and a perspective view (B) of an embodiment of a surgical template for drilling the second bore in the desired angle and position.

FIG. 8 shows two schematic cross-sectional views of the splinted implants implanted in the lower jawbone.

FIG. 9 illustrates the procedure of drilling, placing a pair of tilted implants and locking them according to the present invention.

### DETAILED DESCRIPTION OF THE PREFERRED EMBODIMENTS

The present invention comprises a method of locking two implants together so as to enhance the immediate stability of both implants allowing immediate loading. Said implants are inserted in an angle to the jaw and are locked tightly together thus forming a compound structure that enhances resistance to rotational, occlusal and lateral forces. The use of two pairs of the present invention implants can be a solid foundation for an immediate loading full arch prosthesis which uses only four supporting implants. The principles and features of the present invention will become clear with reference to the drawings and the accompanying descriptions, in which:

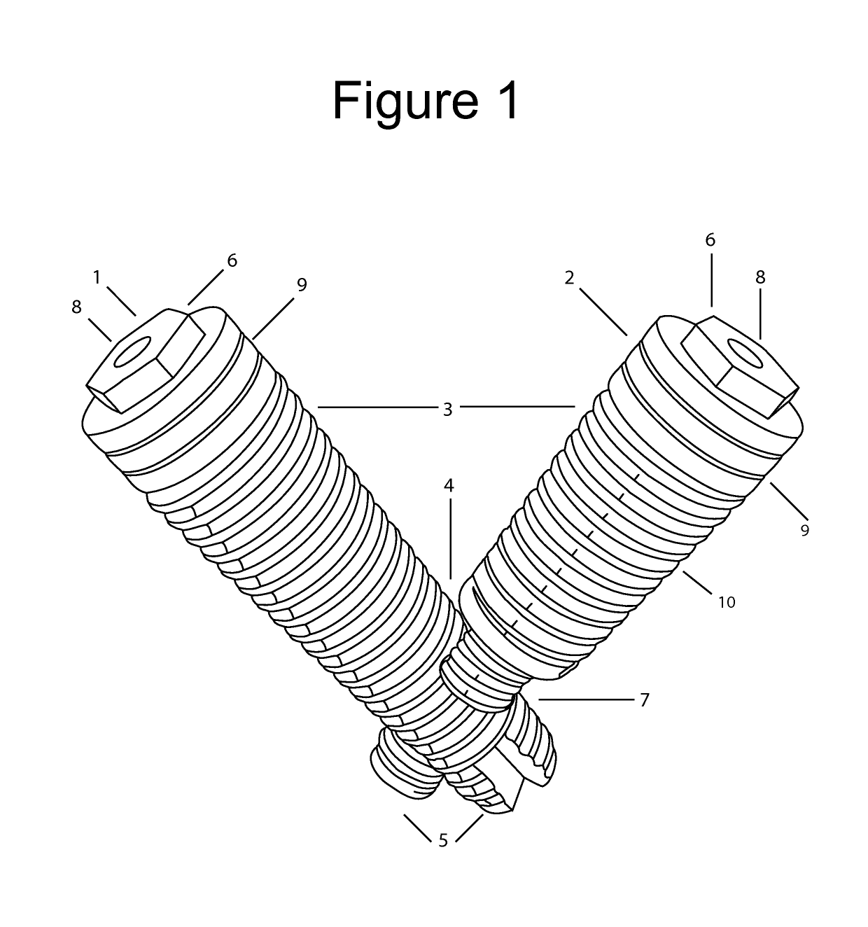

FIG. 1 depicts one preferred embodiment of the present invention. The first inclined implant 1 is inserted in an angle to the occlusal plane, ranging between 20°-60°. The implant includes an implant head 9, threaded shaft 3, a cylindrical bore with female threads 4, into which the second implant 2 is screwed, and self-tapping recess 5. The drilled bore may have a wider opening to easily facilitate the insertion of the smaller apical recess of the second implant. The said implants head 9 comprises of a multifaced outer hexagonal interface 6 and a threaded attachment arrangement for connecting a dental prostheses 8. The said second implant 2 has two parts. The upper part 10 consists of an implant head 9, threaded shaft 3 and external hexagonal interface 6. The lower part consists of a thinner body 7 that fits the bore 4 with its male threads, and apically a self-tapping recess 5. The implants may be made from biocompatible ceramics such as zirconium oxide and/or titanium/titanium alloy.

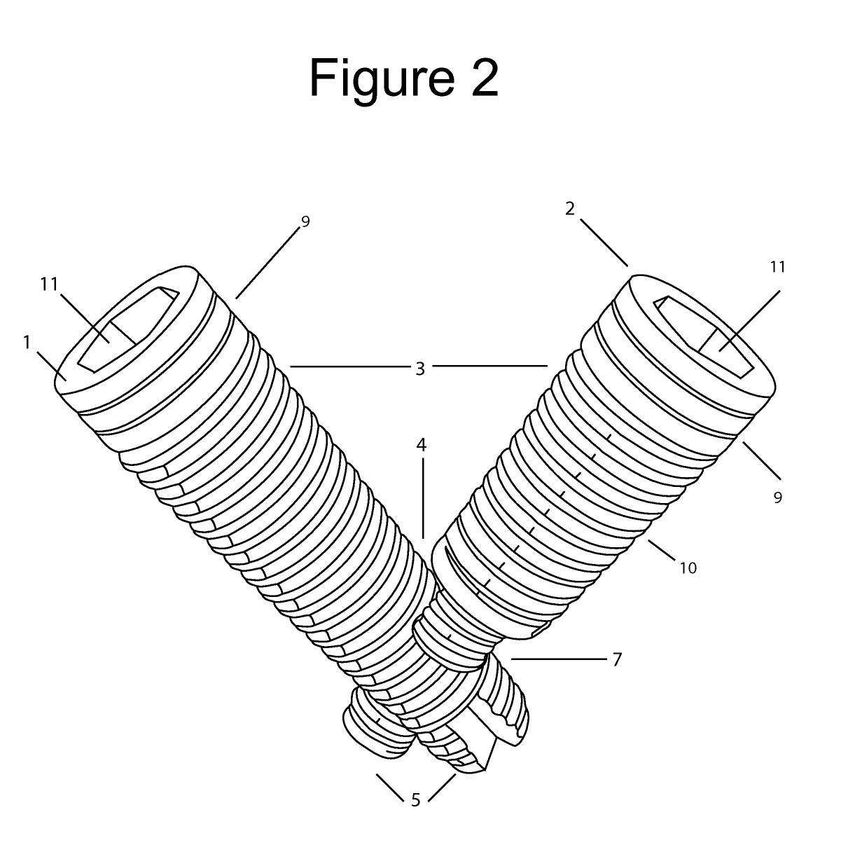

FIG. 2 shows a second embodiment of the present invention in which the implant heads 9 has an internal multifaced hexagonal interface 11.

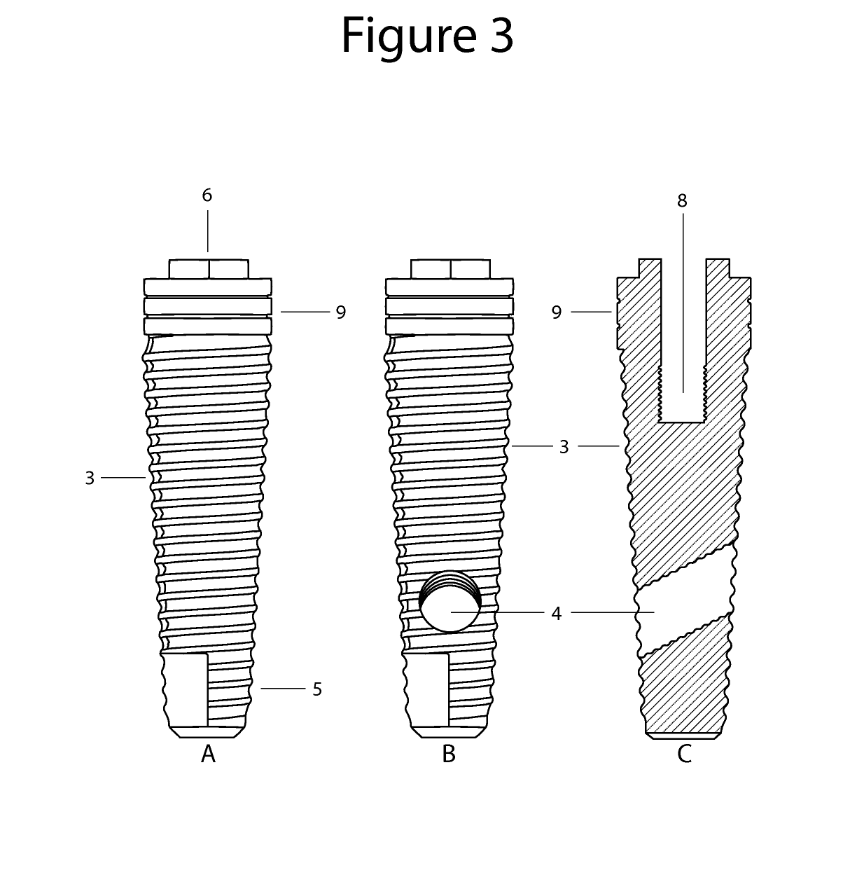

FIG. 3 shows an embodiment of the first implant. The front view FIG. 3A shows the implant head 9, threaded shaft 3, self-tapping apical recess 5, and a multifaced external hex 6. The side view FIG. 3B shows a cylindrical bore with female threads 4 into which the second implant is screwed. The sectional view FIG. 3C shows the cylindrical bore 8 with a threaded apical part to accept a fixation screw for a detachable dental prosthesis. An oblique cylindrical bore 4 with an internally threaded passage into which a second implant is inserted. In one preferred embodiment of the present invention the bore 4 is drilled in an angle of 70° with respect to the longitudinal axis of the said implant. It should be noted that in the scope of the present invention the said bore angle can range between 40°-100°.

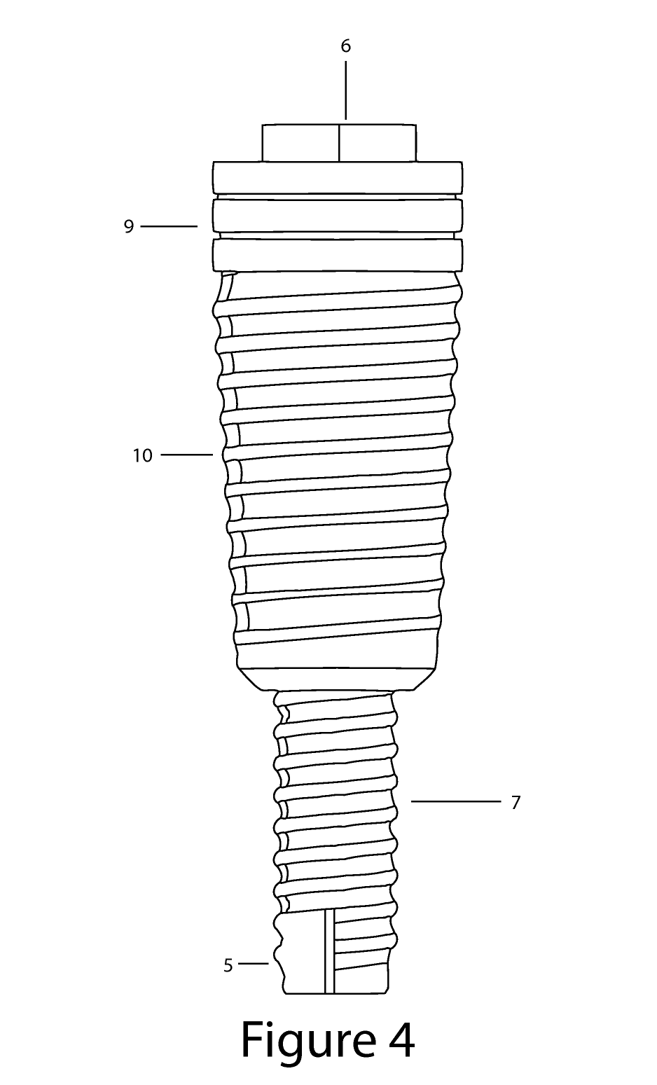

FIG. 4 shows an embodiment of the second implant. An upper threaded shaft 10 consists of an implant head 9 with a multifaced external hex 6. The lower part 7 has a thinner threaded body to fit the cylindrical bore 4 of the first implant 1. At the apical end a self-tapping recess 5.

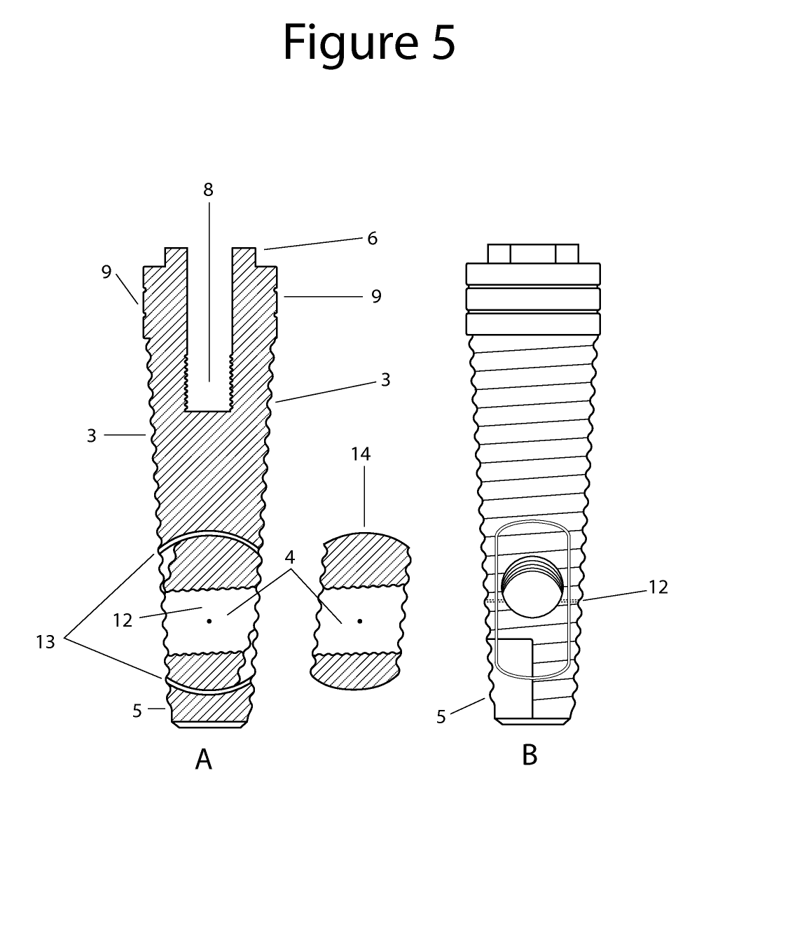

FIG. 5 shows sectional view FIG. 5A and side view FIG. 5B of another embodiment of the first implant wherein the cylindrical bore 4 is seated in a separate moving part 14 within the implant shaft 3 and attached to it with a central pivot 12. The said axis allows pivotal movement of the said bore which allows a broader range of angles, between 40°-100°, to fit the insertion angle of the said second implant. The interspace 13 between the said moving part 14 and the implant shaft 3 should be minimal to allow tight fit movement.

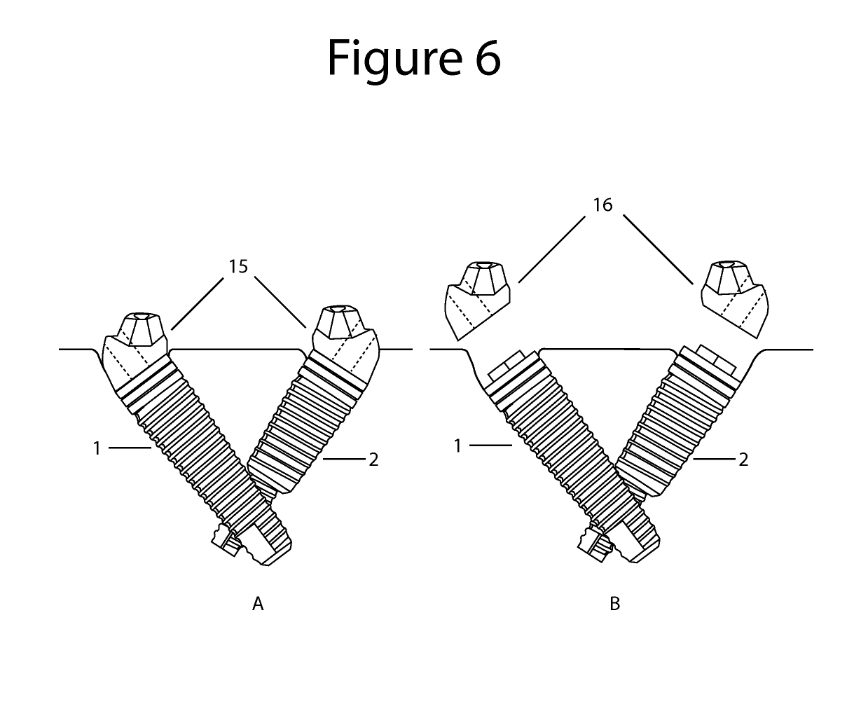

FIG. 6 depicts an embodiment of two one piece implants splinted together, where the prosthetic head 15 and the inclined implant are fabricated as one piece FIG. 6A. The second implant 2 is screwed and locked into the first implant 1 at an angle that can range between 40°-100° and shown here at arbitrarily at 70°. FIG. 6B shows an embodiment of two piece implants with the prosthetic heads 16 separated from the inclined implants 1 and 2.

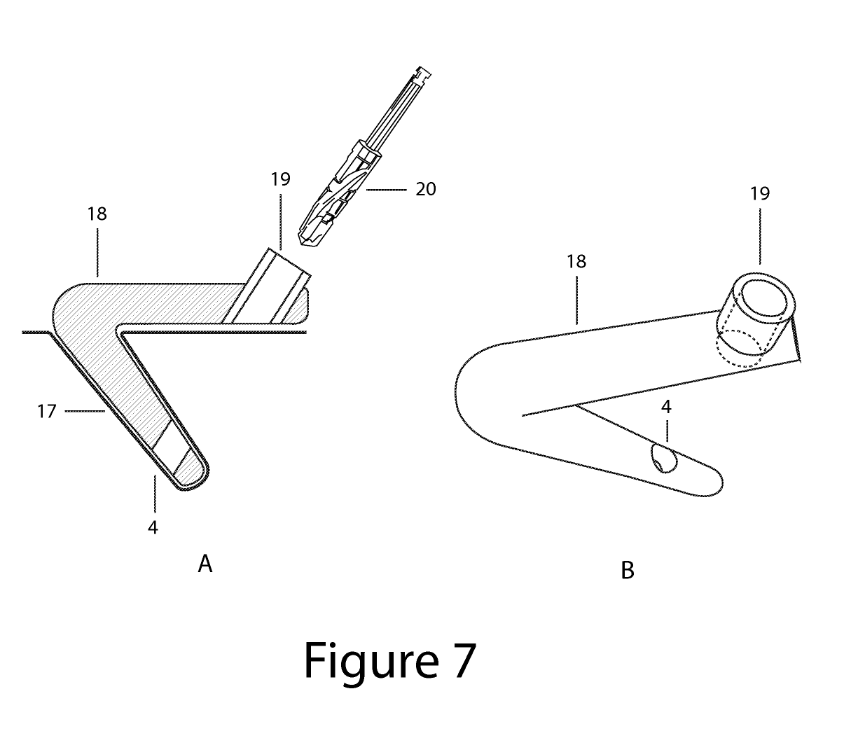

FIG. 7 shows a cross section (FIG. 7A) and a perspective view (FIG. 7B) of one embodiment of a surgical template which facilitates the proper drilling position (angle and distance) for the second implant. The device is used during surgery after drilling a bore for the first implant and inserting a try-in 17. The device comprises of a cylindrical implant body try-in 17 with the desirable angle, width, length and the angled bore 4 at the apical end of the try-in, and an attachment member 18 which is connected to the implant try-in. The connecting member comes with a tilted sleeve 19 for inserting a drill in the desired angle 20.

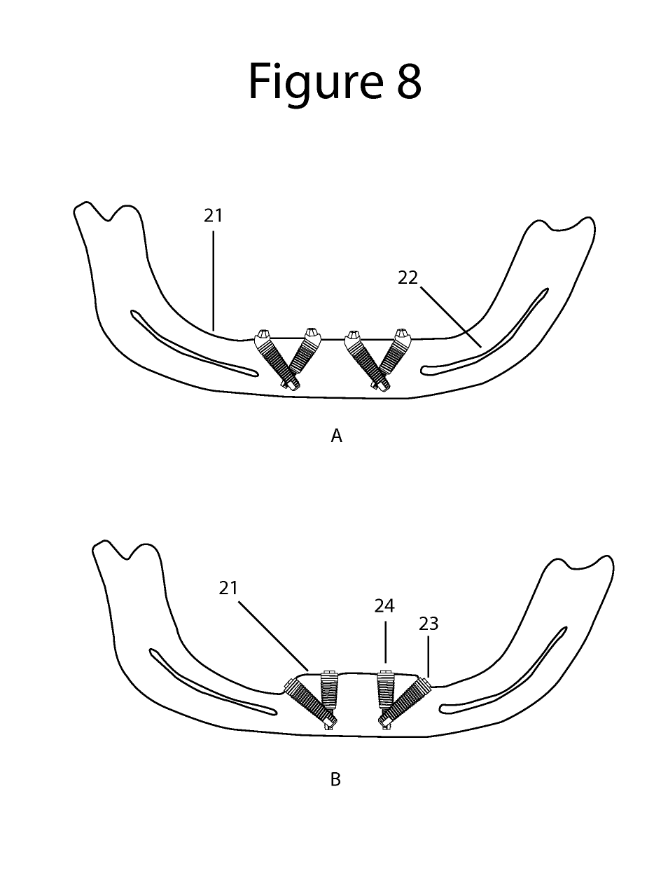

FIG. 8 shows schematic cross-sectional views of the splinted implants implanted in the lower jawbone. The lower jaw is for illustrative purposes only, and the procedure can also be applied in the upper jaw, not shown here. FIG. 8A depicts two couples of implants inserted in an exemplary angle of 55° relative to the bone level 21. The combined angle between the implants is 70° in this case. Note how the present invention avoids the posterior parts of the jaw where there is lack of sufficient bone and escapes proximity to the inferior alveolar nerves and blood vessels 22. FIG. 8B depicts another embodiment of the present invention. Only the first implant 23 is inserted in a 45° angle relative to the bone level 21. The second implant 24 is then inserted perpendicular to the bone level and in a 45° angle to the first inclined implant. This allows the use of a long (up to 25 mm) inclining implant and a shorter second implant to lock it.

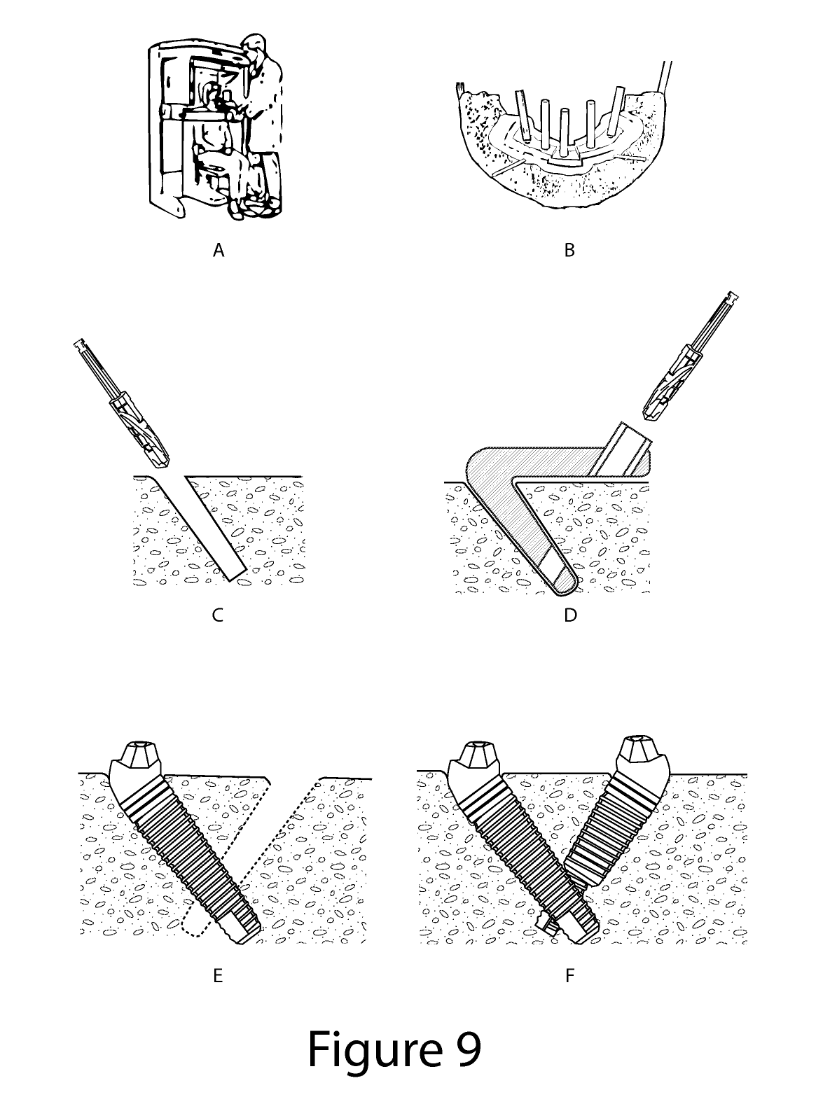

FIG. 9 illustrates the procedure of placing two tilted implants and locking them according to the present invention. It should be noted that the stated steps, features or components used in the description herein does not preclude the presence or addition of one or more steps, features or components.

The first step (FIG. 9A) is to obtain a computerized axial tomography scan (CT) of the patient's jaw and do a treatment plan according to the patient's individual anatomy, choosing the appropriate implants based on the desired inclination angle, length and width. The second step (FIG. 9B) is constructing a surgical template by a laboratory aided by 3D computerized simulation of the jaw, with positioning the appropriate sleeves for drilling the angled bore in the bone. In the third step (FIG. 9C), using the surgical template, the first inclined drill is made in the desired angle and length with respect to the bone surface. The forth step (FIG. 9D) is inserting an implant body try-in into the drilled bone and connecting a prefabricated template as depicted in FIG. 7, and drilling the second bore into the bone. When the drill reaches the implant body try-in the try-in should be pulled out so that the second implant bore can be done to its full length. The fifth step (FIG. 9E) is inserting by rotation the first implant into the bone until said implant advances into a final implant position. In case of a one piece implant the angled head should be perpendicular to the occlusal plane, thus the angled threaded bore of the first implant would be positioned in continuation with the drilled bore of the second implant. In the sixth step (FIG. 9F) the second implant is inserted by rotation into the drilled second bore in the bone and the continual threaded angled bore located in the apical end of the first said implant. The last step is attaching the appropriate angled prosthetic heads in case of using two piece implants.

The present invention described above relates to certain embodiments. However, these embodiments have been presented by way of example only. Other embodiments than those described above are possible within the spirit and scope of the invention, as defined in the appended claims.

What is claimed:

1. A combination of two inclined dental implants, said first implant has an angled threaded bore at the apical end and said second implant comprises an upper coronal threaded shaft and a thinner apical threaded part fitted for the said bore, wherein the second implant is inserted in an angle unto said angled bore located in the apical part of the first implant. The formed coupled structure enhances resistance to rotational, occlusal and lateral forces allowing immediate loading of said dental implants thereof.

2. Dental implants according to claim 1, wherein the implants and inclined abutments are composed as one piece.

3. Dental implants according to claim 1, wherein the implants and inclined abutments are composed as separate two pieces.

4. Dental implants according to claim 1, wherein the dental implants have a length between 15 and 25 mm.

5. Dental implants according to claim 1, wherein the two piece implants heads have an external surfaced polygonal shape with 4, 5, 6, 7, 8, 9 or 10 faces.

6. Dental implants according to claim 1, wherein the two piece implants heads have an internal surfaced polygonal shape with 4, 5, 6, 7, 8, 9 or 10 faces.

7. Dental implants according to claim 1, wherein the insertion angle of the second implant into the first implant is in the range of 40°-100°.

8. Dental implants according to claim 1, wherein the first implant has a fixed insertion bore for the second implant in an angle ranging between 40°-100°.

9. Dental implants according to claim 1, wherein the first implant has a non fixed insertion bore in a separate adjustable hinged part, allowing an insertion angle between 40°-100°.

10. Dental implants according to claim 1, wherein the first implant is perpendicular to the occlusal plane and the second implant is inserted at an approximate angle of 45°.

11. Dental implants according to claim 1, wherein the dental implants are made from titanium/titanium alloy.

12. Dental implants according to claim 1, wherein the dental implants are made from zirconium oxide or zirconium oxide/aluminum mixture.

13. A device comprised of a cylindrical implant body try-in with the desirable angle, width, length and an angled bore at the apical end of the try-in, and an attachment member which is connected to the implant try-in. The connecting member comes with a tilted sleeve for inserting a drill in a desired angle for the second implant.

14. The device according to claim 13 wherein the angle between the implant body try-in and the attachment member is between 40°-100°.

15. The device according to claim 13 wherein the length of the implant body try-in is between 15 and 25 mm.

16. The device according to claim 13 wherein the width of the implant body try-in is between 3-6 mm.

17. The device according to claim 13 wherein the drilled bore at the apical end of the implant body try-in is in an angle ranging between 40°-100°.

18. The device according to claim 13 wherein the tilted sleeve at the end of the connecting member is in an angle between 40°-100° in relation to the implant body try-in.
